(19) United States
(12) Patent Application Publication
(10) Pub. No.: US 2025/0314876 A1
(43) Pub. Date: Oct. 9, 2025

(54) IMAGING DEVICE AND IMAGING SYSTEM

(71) Applicant: The University Court of The University of Edinburgh, Edinburgh (GB)

(72) Inventors: Gareth WILLIAMS, Edinburgh (GB); Elvira WILLIAMS, Edinburgh (GB); John GIRKIN, Edinburgh (GB)

(73) Assignee: The University Court of The University of Edinburgh, Edinburgh (GB)

(21) Appl. No.: 18/866,736

(22) PCT Filed: May 16, 2023
(86) PCT No.: PCT/GB2023/051284

§ 371 Date: Nov. 18, 2024

(30) Foreign Application Priority Data
May 19, 2022 (GB) 2207383.7

(51) Int. Cl. G02B 26/10; G02B 26/08

(52) U.S. Cl. CPC G02B 26/10; G02B 26/0816

(57) ABSTRACT

An optical device comprises a plurality of optical components comprising at least one primary mirror and further comprising at least one scanning mirror component and/or at least one spatial light modulator and/or at least one digital mirror, wherein the plurality of optical components are configured to direct light from an input/output module to an objective module and from the objective module to the Input/output module and to manipulate a position and/or pattern of the light; and a mono-block structure In which the plurality of optical components is mounted, wherein the mono-block structure is a continuous single structure having walls and a base.

### FIELD

The present invention relates to an imaging device and imaging system, for example an optical scan head and an imaging system comprising said scan head.

### BACKGROUND

The use of optical techniques to interrogate a wide range of samples, for example to interrogate a range of samples from semiconductors to biological tissue, has gained wide adoption over the past decades.

In particular, beam scanned optical systems may enable a wide range of optical techniques and spectroscopies to be accessed. High spatial and temporal resolution may be obtained if required.

Translation of beam scanned optical systems into different use cases that may be used outside the typical laboratory has been limited by, for example, a stability of optical alignment that may be achieved, and a size and weight of typical previous systems. In particular, the alignment and/or size and/or weight and/or thermal stability of scanning optics may limit the use of scanning systems outside the laboratory. Beam scanned imaging systems may typically be limited to the laboratory bench or to other highly controlled environments.

Furthermore, there is a drive to increase the amount of optical information captured through increased resolution in spectral (wavelength), temporal and spatial dimensions. In some circumstances, this may be achieved through integrated optical design using reflective rather than transmissive optics which then need to be accurately aligned and this alignment maintained. An increase in optical information captured provides an ever-increasing data load, which may limit acquisition speed. Limited acquisition speed may be an issue in areas such as in vivo imaging in which the sample is moving; capture of kinetic events; or avoiding damage such as photobleaching of samples during acquisition. High speed scanning linked to reliable optical positioning may overcome many of these challenges.

### SUMMARY

In a first aspect, there is provided an optical device comprising: a plurality of optical components comprising at least one primary mirror and further comprising at least one scanning mirror component and/or at least one spatial light modulator and/or at least one digital mirror, wherein the plurality of optical components is configured to direct light from an input/output module to an objective module and from the objective module to the input/output module and to manipulate the position and/or pattern of the light; and a mono-block structure in which the plurality of optical components is mounted, wherein the mono-block structure is a continuous single structure having walls and a base.

The plurality of optical components may comprise at least one scanning mirror component. The manipulating of the light may comprise scanning a position of the light.

The plurality of optical components may comprise at least one scanning mirror component. The manipulating of the light may comprise forming a light pattern.

The plurality of optical components may comprise at least one scanning mirror component. The manipulating of the light may comprise scanning a light pattern.

The manipulating of the light may comprise pattern light projection.

The optical device may further comprise the input/output module. The optical device may further comprise the objective module. The input/output module may be configured to receive and/or generate incoming light and to collect reflected and/or transmitted light for sensing or detection. The objective module may be configured to transmit light to and/or receive light from a target.

Components of the input/output module may be mounted in the mono-block structure. Components of the objective module may be mounted in the mono-block structure.

The input/output module may be removably attachable to the mono-block structure. The objective module may be removably attachable to the mono-block structure.

The mono-block structure may be formed by machining a block of a material. The material may comprise aluminium.

The mono-block structure may be formed by at least one of: machining, milling, moulding, casting, additive manufacture.

The mono-block structure may be formed of aluminium. The mono-block structure may be formed of carbon fibre.

The optical device may further comprise a lid. The mono-block structure and lid may be configured to fit together to form an enclosure providing ingress protection.

The mono-block structure may comprise one or more heat sink elements. Each heat sink element may comprise a respective plurality of slots or fins. The slots or fins may be formed from the mono-block structure, optionally by machining the mono-block structure. The slots or fins may extend partially through a wall of the mono-block structure.

The mono-block structure may comprise a plurality of mounting points for direct mounting of at least some of the plurality of optical components to the mono-block structure. The mounting points may be formed from the mono-block structure, optionally by machining the mono-block structure.

The at least one primary mirror may be mounted to at least one wall of the mono-block structure such that the at least one wall of the mono-block structure acts as a fixed backplate to the at least one primary mirror.

The optical device may be configured to perform at least one of: confocal imaging, microendoscopy, multiphoton imaging, free-space imaging, non-linear imaging, ultrafast process imaging, fluorescence imaging, time-resolved fluorescence imaging, Raman imaging, time-resolved Raman imaging.

The light may comprise at least one of visible light, infrared light. A wavelength of the light may be between 300 nm and 5 μm.

A weight of the optical device may be between 1 kg and 50 kg, optionally between 10 kg and 25 kg, further optionally between 15 kg and 20 kg. A depth, width and/or height of the optical device may be between 5 cm and 100 cm, optionally between 10 cm and 50 cm. A height of the mono-block structure may be between 5 cm and 100 cm, optionally between 5 cm and 25 cm, further optionally between 10 cm and 20 cm. A depth of the mono-block structure may be between 5 cm and 100 cm, optionally between 20 cm and 50 cm, further optionally between 30 cm and 40 cm. A width of the mono-block structure may be between 5 cm and 100 cm, optionally between 20 cm and 50 cm, further optionally between 30 cm and 40 cm.

The optical device may further comprise a detector and detector optics. At least part of the detector and/or the detector optics may be mounted in the mono-block structure.

The optical device may further comprise a light source and light source optics. At least part of the light source and/or the light source optics may be mounted in the mono-block structure.

In a further aspect, there may be provided a system comprising an optical device as claimed or described herein. The system may further comprise a detector module configured to perform the sensing or detection. The system may further comprise an imaging fibre that is attachable to the objective module. The system may further comprise a further fibre configured to provide light from the input/output module to the detector module. The further fibre may act as a system pinhole.

The system may be portable. The system may further comprise a moveable arm onto which is mounted the optical device.

In a further aspect, which may be provided independently, there is provided a method comprising: directing, by a plurality of optical components, light from an input/output module to an objective module, wherein the plurality of optical components comprises at least one primary mirror and further comprises at least one scanning mirror component and/or at least one spatial light modulator and/or at least one digital mirror configured to manipulate a position and/or pattern of the light, and wherein the plurality of optical components is mounted in a mono-block structure, wherein the mono-block structure is a continuous single structure having walls and a base; and directing, by the plurality of optical components, light from the objective module to the input/output module.

In a further aspect, which may be provided independently, there is provided a method comprising: forming or receiving a mono-block structure, wherein the mono-block structure is a continuous single structure having walls and a base; and mounting a plurality of optical components within the enclosure, wherein the plurality of optical components comprises at least one primary mirror and further comprises at least one scanning mirror component and/or at least one spatial light modulator and/or at least one digital mirror, and wherein the plurality of optical components are configured to direct light from an input/output module to an objective module and from the objective module to the input/output module and manipulate a position and/or pattern of the light.

The mounting may comprise directly mounting at least some of the optical components to a plurality of mounting points of the mono-block structure.

The mounting may comprise mounting at least one primary mirror to at least one wall of the mono-block structure such that the at least one wall of the mono-block structure acts as a fixed backplate to the at least one primary mirror.

There may be provided an apparatus, method or system substantially as described herein with reference to the accompanying drawings.

Features in one aspect may be provided as features in any other aspect as appropriate. For example, features of a method may be provided as features of an apparatus and vice versa. Any feature or features in one aspect may be provided in combination with any suitable feature or features in any other aspect.

### BRIEF DESCRIPTION OF THE DRAWINGS

Embodiments of the invention are now described, by way of non-limiting example, and are illustrated in the following figures, in which:

FIG. 1 is a schematic illustration of a mono-block structure that forms part of an optical scan head in accordance with an embodiment;

FIG. 2 is a schematic illustration of an optical scan head in accordance with an embodiment; and

FIG. 3 is a photograph of the optical scan head of FIG. 2.

### DETAILED DESCRIPTION

A beam scanned optical scan head comprising a mono-block structure is presented, along with embodiments of such a scan head and imaging systems that it may enable. Potential issues around stability, size and weight of an optical system are addressed by incorporating scanning optical components into a scan head having a mono-block structure that is machined from a single piece of material. The scan head may be highly robust and may have a small footprint that can enable various embodiments of beam scanned optical systems. For example, in one embodiment the scan head is used in clinical microendoscopy. In a further embodiment, the scan head is used in a portable imaging platform which is able to be mounted, for example on a moveable arm to give access to samples in various orientations. Embodiments having integrated detector arrays with optical timing collection and storage electronics along with colocation of system drive electronics may provide an extremely robust and compact high-throughput optical imaging platform. In some embodiments, features may be machined to the mono-block to minimise vibrational modes across the scan head.

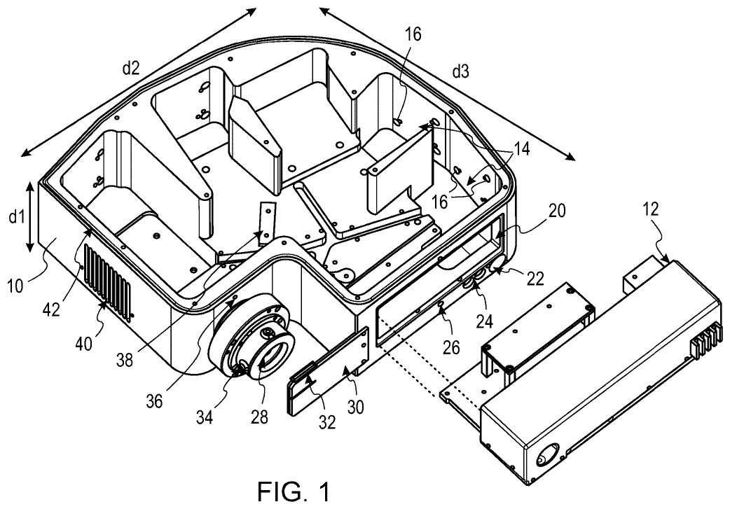

FIG. 1 is a schematic illustration of a main mono-block 10 for an optical scan head 50 in accordance with an embodiment. The main mono-block 10 is illustrated in an isometric view. The main mono-block 10 may also be referred to as a mono-block structure or monolithic structure, or as a housing. The optical scan head 50 may also be referred to as a monolithic optical scan head or mono-block optical scan head. The terms monolithic or mono-block may be used to refer to a device that integrates optical and/or electrical components into a single piece of material, which may act as part of the optical mounting system.

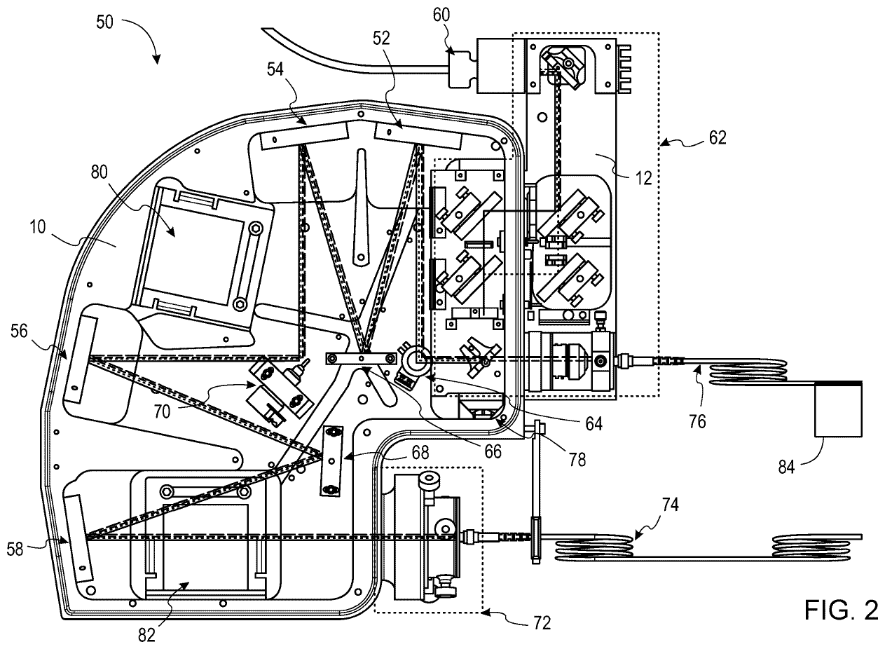

FIG. 1 also shows a number of components that are attached or attachable to the main mono-block 10. FIG. 2 is a schematic illustration of an monolithic optical scan head comprising the main mono-block 10 and various optical components which are described in detail below.

The main mono-block 10 is machined from a single piece of aluminium using a known machining technique, for example a known milling technique, for example with long series cutters. A computer controlled mill may be used. A skim cut of the block at least 24 hours prior to full machining may reduce block stress and maximises the final stability. In other embodiments, any suitable method (for example, casting, moulding or additive manufacture) and any suitable material may be used, where the material is continuous throughout the mono-block. For example, the main mono-block may be cast in a suitable material and subsequently stress relieved and finally machined.

The material of the mono-block, which in the embodiment of FIG. 1 is a single piece of aluminium, forms the base and walls of the main mono-block. In embodiments including the embodiment of FIG. 1, the single piece of aluminium also forms heat dissipation mechanisms and optical mounting mechanisms of the main mono-block 10.

A wall thickness of the main mono-block 10 ranges from 10 to 20 mm. Different portions of the wall(s) may have different thicknesses as illustrated in FIG. 1. A base thickness of the main mono-block 10 ranges from 5 to 50 mm. Different portions of the base may have different thicknesses. In other embodiments, different thicknesses may be used.

An aluminium lid (not shown) is configured to be placed onto top of the main mono-block 10 to form an enclosure. In the embodiment of FIG. 1, the aluminium lid is 10 mm in thickness. In other embodiments, a different thickness may be used. When the lid is positioned on top of the main mono-block 10, the combination of the main mono-block 10 with the lid may form a robust housing that is at least partially resistant to ingress, for example to ingress of moisture and/or dust. The scan head 50 may have an IP rating for ingress protection.

Surfaces of the main mono-block 10 and the aluminium lid are black anodised. The use of black anodised surfaces in the interior of the main mono-block may reduce internal reflections. The anodising layer may ensure electromagnetic shielding and insulation. Selected portions of an anodising layer produced by the black anodising may be removed to facilitate electrical earthing of the main mono-block and/or gluing of components. In other embodiments, any suitable surface treatment of the aluminium may be used, for example powder coating.

In the embodiment of FIG. 1, a total weight of a scan head including the main mono-block 10, aluminium lid and all functioning parts is around 18 kg. A height of the main mono-block 10 is indicated as d1 in FIG. 1. A depth of the main mono-block 10 is indicated as d2 in FIG. 1. A width of the main mono-block is indicated as d3 in FIG. 1. In the embodiment of FIG. 1, the height d1 of the main mono-block 10 is 14.5 cm; the depth d2 of the main mono-block 10 is 36.2 cm; and the width d3 of the main mono-block 10 is 33.7 cm. In other embodiments, different dimensions, different proportions and/or a different weight of main mono-block 10 and of an overall device or system comprising main mono-block 10 may be used.

A size of the main mono-block 10 is determined by an optical beam path of optical components that the main mono-block is designed to house. The optical components are selected such that the main mono-block 10 is sufficiently small to stand on a medically approved trolley.

In the embodiment of FIG. 1, a secondary enclosure 12 is configured such that it is attachable to the main mono-block 10 and detachable from the main mono-block 10. An opening 20 is formed in the wall of the main mono-block 10 to accept the secondary enclosure 12 such the secondary enclosure 12 can be placed and secured into the main mono-block 10. The secondary enclosure 12 is configured to house an input/output module 62 which in the present embodiment comprises a laser filtering block as described below with reference to FIG. 2.

The secondary enclosure 12 is smaller than the main mono-block 10. A combined width of the main mono-block 10 and secondary enclosure 12 when the secondary enclosure 12 is attached to the main mono-block 10 is 41.5 cm. The secondary enclosure 12 is configured to be sealed to the main mono-block 10 after alignment of the secondary enclosure 12 and main mono-block 10. In other embodiments, a structure similar in structure or function to that of secondary enclosure 12 is built into main mono-block 10, and no secondary enclosure 12 is attached or attachable to main mono-block 10. In such embodiments, components that are described below as forming part of the laser filtering block may be mounted within the main mono-block 10.

A section of a wall 14 of the main mono-block 10 comprises a set of mounting holes 16. The mounting holes 16 are for mounting optical mirror front plates and adjusters (not shown in FIG. 1) as described further below, thereby acting as a direct mounting and positioning mechanism for primary optics.

The main mono-block 10 further comprises one or more cable routing channels. The cable routing channels are configured to allow routing of cables providing power and/or signal to and/or from one or more galvo mirrors as described below. The cable routing channels may additionally or alternatively be configured to allow routing of cables to provide power to a safety diode and/or LED, for example to allow routing of cables to an LED laser warning light coupled to port 36 as described below.

Ports 22, 24 are provided adjacent to the opening 20 that allows the secondary enclosure 12 to be attached to the main mono-block 10. One port 22 is for a Cat6 shielded RJ45 passthrough connector to allow transfer of galvo sync signals, LED warning light power and power level detection data return. Further ports 24 are passthrough ports for strain relieved galvo power cable which is used to power the galvo mirrors 62, 70 as described below, for example via galvo drivers 80, 82. An external earthing point 26 is also provided in the vicinity of the ports 22, 24. In the embodiment of FIG. 1, the external earthing point comprises an M6 thread for an earthing stud.

A fibre port 28 is provided for connection to an imaging fibre. The imaging fibre may comprise an imaging fibre bundle comprising a plurality of imaging cores. In the embodiment of FIG. 1, the fibre port comprises an FC connectorized fibre port. In other embodiments, a different fibre connection type may be used.

A protective plate 30 is configured to block laser light if the laser light were to be activated without a fibre attached to the scan head at fibre port 28. A secondary function of the protective plate 30 is to provide strain relief on an imaging fibre (not shown in FIG. 1) when the imaging fibre is attached to fibre port 28. A liftable shutter 32 is configured to block laser light from being directly visible when no imaging fibre is attached to fibre port 28.

An XYZ and rotation mount 34 allows fine alignment of the imaging fibre attached to fibre port 28. In the embodiment of FIG. 1, the fibre port 32 and the XYZ and rotation mount 34 together form part of an imaging objective unit 72 that is detachable from the main mono-block 10 and may be changeable as described below with reference to FIG. 2.

A port 36 near the fibre port 32 is for a LED laser warning light (not shown in FIG. 1) which is a white LED that illuminates when laser light is emitting from the scan head.

The main mono-block 10 further comprises a plurality of internal optical mounting points 38 configured to attach optics holders (not shown in FIG. 1) for static mirrors and/or galvo mirror heatsinks and/or further optical components. The mounting points are formed from the main mono-block 10, for example by machining features into the main mono-block 10. Any suitable optical components may be mounted to the main mono-block 10 using optical mounting points 38. By forming the mounting points directly from the main mono-block 10, a stable mounting may be achieved. The mounting points 38 formed from the main mono-block may be used to provide explicit coarse alignment, with fine adjustment thereafter.

The main mono-block 10 further comprises a milled heat sink component 40 which is positioned adjacent to a position in which a galvo driver 82 (not shown in FIG. 1) is to be mounted in the main mono-block 10. The milled heat sink component 40 comprises a plurality of slots or fins that are formed within the material of the main mono-block 10, for example by machining slots or fins into the main mono-block 10. The milled heat sink component is provided to increase heat dissipation with no cut through. The milled heat sink component 40 does not extend within the whole width of the wall of the main mono-block 10 so that ingress protection is not compromised. A thin wall remains between the fins and the heat producing components within the main mono-block for heat transfer.

In the embodiment of FIG. 1, at least one further milled heat sink component 40 is provided on the wall of the main mono-block 10 but is positioned such that it is not visible in FIG. 1. A respective heat sink component 40 may be provided in the vicinity of each galvo driver 80, 82 and/or in the vicinity of any other component that may be expected to output a substantial amount of heat that is required to be dissipated. Heat sinks may be formed in other positions if the main mono-block 10 is configured to hold other electronic components that require heat sinking, for example a laser driver and integrated laser diode. In other embodiments, any suitable number and type of heat sink may be formed from the main mono-block 10. The heat sink(s) may be formed from the main mono-block 10 using any suitable technique.

The main mono-block 10 further comprises a plurality of feet attachment points on the base of the main mono-block 10, which are not visible in FIG. 1. In the embodiment of FIG. 1, five M6 threaded feet attachment points are formed on the base of the main enclosure 10. Feet may be attached to the feet attachments points. Other embodiments may use such attachment points for other mounting types, for example on a movable arm.

A channel 42 is formed at the top of the main mono-block 10. The channel 42 is for holding a sealing O-ring (not shown in FIG. 1). In the embodiment of FIG. 1, the channel 42 is a 3 mm round channel and a 3 mm sealing O-ring is used. The top of the main mono-block 10 is sealable against ingress by use of the O-ring (not shown) placed in the channel 42 between the main mono-block 10 and the lid (not shown). Further O-rings (not shown) are used to seal screw fixings of the lid.

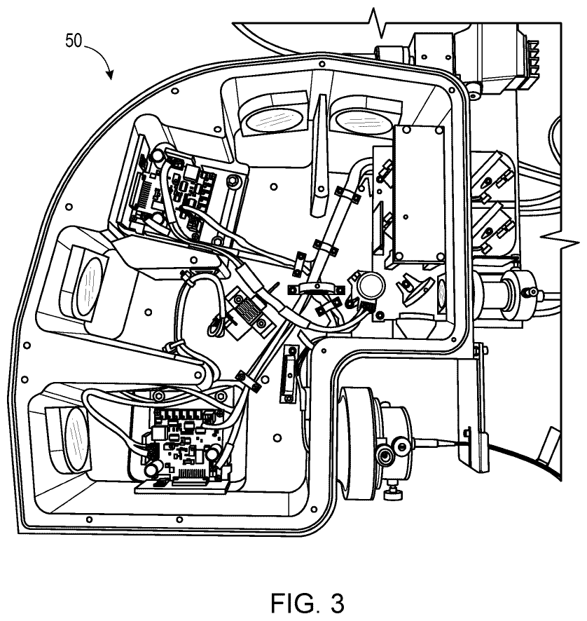

FIG. 2 is a schematic illustration of a monolithic optical scan head 50 which comprises a main mono-block 10 as described above in relation to FIG. 1. Main optics and electrical components of the scan head 50 are illustrated in FIG. 2. FIG. 2 also illustrates beam paths for light passing through the scan head 50 when the scan head is in operation. To reduce the complexity of FIG. 2, wiring is not shown in FIG. 2. FIG. 3 is a photograph of scan head 50, in which wiring is visible along with other components.

The scan head 50 comprises four main mirrors 52, 54, 56, 58 which may also be described as primary mirrors. The four main mirrors 52, 54, 56, 58 are each mounted in a respective custom mount (not shown in detail in FIG. 2). Each custom mount is secured with three springs which pull against three corresponding adjuster assemblies. In other embodiments, any suitable mount may be used.

A wall of the main mono-block 10, for example part 14 of the main mono-block 10, acts as a direct backplate for mounting the primary mirror. The custom mount is attached to fixing holes 16 that are formed in the main mono-block 10. By mounting the primary mirrors directly to the main mono-block 10, improved optical stability may be obtained when compared to affixing a conventional mount to a housing.

Furthermore, the optical components may be held in a controlled position such that an amount of adjustment of the optical component that is required in manufacture may be reduced. In some embodiments, adjusting screws may be locked in place, which may further increase robustness. At least a coarse alignment of the optical components may always be maintained due to direct mounting to the main mono-block 10. Additionally, by mounting the primary mirrors directly to the main mono-block 10, the scan head may be made as small as possible given the optical layout and optical components.

Mirrors 52 and 54 each comprise a respective spherical mirror. Mirrors 52 and 54 are configured to reimage laser light on the second galvo mirror 70 which is described below. Mirrors 52 and 54 may be considered to form a first mirror pair. Mirror 56 comprises a spherical mirror. Mirror 58 comprises a further spherical mirror which is configured for translating a beam of laser light to a focusing objective of the imaging objective unit 72 as described below.

The scan head 50 of FIG. 2 comprises an input/output module 62 comprising a secondary enclosure 12 which was also illustrated in FIG. 1. In other embodiments, the input/output module 62 may be considered to be separate from the scan head 50 and coupled to the scan head 50. The input/output module 62 is configured to be detachable from the main body of the scan head 50 which comprises the main mono-block 10. The input/output module 62 is configured to be replaceable with an alternative input/output module 62, for example to perform a different imaging method. In other embodiments the input/output module 62 forms part of the main mono-block 10 and is not configured to be detachable or interchangeable.

Incoming laser light is provided to the input/output module 62 by an optical fibre and optical fibre connector 60 providing collimated fibre output from a supercontinuum laser system (not shown).

In the embodiment of FIG. 2, the input/output module 62 comprises a laser filtering block comprising the secondary enclosure 12. Mounted in the secondary enclosure 12 are a plurality of optical components that are configured to provide optical filtering. The optical component for filtering the collimated fibre output from the laser system down to two desired excitation bands along with beam expansion to ensure the back of the imaging objective is completely filled. Filters are used to split the visible portion of the incoming laser light into two bands controlled by shutters.

In the embodiment of FIG. 2, the input/output module 62 also acts as a beam dump for an infrared portion of the incoming laser light that is not required. The infrared portion of the incoming light is passed to a heat sink of the input/output module for dissipation.

A multimode fibre 76 is shown attached to a port of the input/output module 62. In the embodiment of FIG. 2 the multimode fibre 76 is an FC connectorized multimode fibre having a 100 μm core for fluorescence connection. The multimode fibre 76 is configured to collect fluorescent light and transport the fluorescent light to a spectrometer enclosure 84, which is schematically represented in FIG. 2 by a box. The spectrometer enclosure 84 may also be referred to as a detector module. The spectrometer enclosure 84 comprises a detector (not shown) and detector optics (not shown).

The multimode fibre 76 acts as the system pinhole. By using an optical fibre as the system pinhole to direct collected light from the scan head 50 to be directed to a remote detection module, a size of the scan head 50 may be minimized, which may enable the scan head 50 to be placed conveniently on a medical trolley. In other embodiments, a detection module comprising a detector and detector optics may be integrated into the scan head, for example underneath the scanning system. Integration of the detection module may provide a more integrated and robust device.

A laser monitor diode 78 picks up residual laser light that passes through a final dichroic mirror of the input/output module 62.

The scan head 50 further comprises a first galvo mirror 64 which is positioned close to the laser filtering block 62. The first galvo mirror 64 comprises a galvanometer-based scanning motor with an optical mirror mounted on the shaft such that the optical mirror provides a raster scan in an X direction. The first galvo mirror 64 is mounted in a custom heatsink (not shown in FIG. 2) which is configured to dissipate heat, for example heat produced by the scanning motor of the first galvo mirror 64.

The scan head 50 further comprises further mirrors 66 and 68, each of which is a folding planar mirror.

The scan head 50 further comprises a second galvo mirror 70. The second galvo mirror 70 comprises a galvanometer-based scanning motor with an optical mirror mounted on the shaft such that the optical mirror provides a raster scan in a Y direction. The second galvo mirror 70 is mounted in a custom heatsink (not shown in FIG. 2) which is configured to dissipate heat, for example heat produced by the scanning motor of the second galvo mirror 70.

The scan head 50 further comprises a removable imaging objective unit 72 which comprises the fibre port 32 and XYZ and rotation mount 34 as described above with reference to FIG. 1. The imaging objective unit 72 may also be referred to as an objective module. The imaging objective unit 72 is attachable and detachable from the main mono-block 10, and may be interchangeable with alternative imaging objective units, for example imaging objective units configured to perform a different imaging methods. In other embodiments, components of the imaging objective unit may be individually detachable and interchangeable. In further embodiments, components of the imaging objective unit 72 may be housed within the main mono-block 10 and a detachable imaging objective unit 72 may not be used.

The XYZ and rotation mount 34 contains a 20×0.5 NA objective lens. An imaging fibre 74 is shown attached to the fibre port 32. A fibre mounting system of the imaging objective unit 72 (not shown in detail in FIG. 2) provides direct coupling of the imaging fibre to the scan head 50, enabling X, Y, Z and rotational adjustment of the fibre position relative to the objective. The imaging objective unit 72 may be designed to accommodate the use of an imaging fibre bundle 74 that is not symmetric and/or is not round and/or requires a specific alignment relative to the objective.

The scan head 50 further comprises a first driver board 80 which is configured to drive the first galvo mirror 64, and a second driver board 82 which configured to drive the second galvo mirror 70. Each of the driver boards 80, 82 is attached to a respective wall of the main mono-block 10 so that heat from the driver boards 80, 82 may be dissipated by the main mono-block 10. In particular, integrated heat sinks 40 are positioned close to the driver boards 80, 82 and are used to facilitate heat dissipation from the driver boards 80, 82.

In use, incoming laser light from a supercontinuum laser is collimated and is input via optical fibre and optical fibre connector 60. This light is split into visible and infrared light portions via a dichroic mirror of the input/output module 62, with the infrared portion being sunk into a heat sink of the input/output module 62. Following this, the power is reduced using a neutral density filter and then further split into two colour bands with another dichroic of the input/output module 62. The beam is expanded to achieve a beam waist of between 3 and 5 mm. The beams pass two shutters of the input/output module 62, and are then recombined, filtered and then sent to the scan optics via a final multiband dichroic mirror of the input/output module 62.

The visible light that is output by the input/output module is scanned in the X direction by the first galvo mirror 64 then reimaged by primary mirrors 52 and 54, which are two 150 mm focal length concave mirrors, onto the second galvo mirror 70. Specifically, light passes from the first galvo mirror 64 to mirror 52, from mirror 52 to mirror 66, from mirror 66 to mirror 54, and then from mirror 54 to second galvo mirror 70.

The second galvo mirror scans the light in Y. The light is then relayed to the back of the 20× imaging objective via one 150 mm and one 200 mm mirror, which expand the beam to ≥8 mm to fill the back of the objective. Specifically, light from the second galvo mirror 70 is passed to mirror 56, then from mirror 56 to mirror 68, then from mirror 68 to mirror 58, and then to the imaging objective unit 72. At the back plane of the objective a stationary spot is formed with changing angle.

The galvo mirrors are driven independently by two digital-to-analogue converters (not shown). The result is a raster scan across the proximal end of the imaging fibre bundle selectively coupling into individual fibre cores.

Fluorescence returning from the sample returns up through the same fibre core and is de-scanned through the same optical path as the excitation light. The term de-scanning may refer to the use of an optical path that is the same as the optical path of the incoming light, but in reverse. As the scan path is changing far slower than the speed of light there is negligible change in the scan path during the excitation/emission time.

Returning fluorescence passes through the dichroic mirror of the input/output module 62, is filtered by an emission filter to remove any remaining excitation light and is coupled into a fibre 76 with a 10× objective. This fibre 76 then directs the fluorescence into a detector (not shown) of spectrometer enclosure 84.

The scan head 50 of FIGS. 1 to 3 may provide optical input and output as part of a single mono-block for light sources and optical collection and delivery. An input/output module 62 is directly mounted onto a main body of the scan head 50 and provides light source(s), their combining and direction into the scanning optics, collection, and delivery of returning light to a secondary objective and the system pinhole.

The design of the scan head 50 may provide inherent optical stability to thermal fluctuation and enhanced mechanical stability to shock. Optics mounted are fully reflective along the beam path to the imaging objective and may provide achromatic performance over a wavelength range of at least 300 nm to 5 μm.

The monolithic optical scan head 50 may be used to provide an environmentally robust beam scanning system, for example an environmentally robust beam scanning microscopy system. The beam scanning system may be mechanically robust. The beam scanning system may be thermally robust. The beam scanning system may be robust with regard to providing ingress resistance, for example ingress of moisture and/or dust.

The monolithic optical scan head may enable a reduced system footprint. The scan head may be directly attached onto a static or moveable mount. The scan head may be adjusted to any orientation to the sample including rotation in any axis.

The optical scan head 50 may be used to facilitate a portable beam scanning system. Portability may be enabled through integration of optical components into a single mono-block design. In some embodiments, portability may be further enabled by the use of low powered light sources which may allow the scan head to be battery-powered. Detection may be performed via a close coupled low power detector, or via an optical fibre to a remote battery powered detector system. The close coupled detector may comprise a detector that is integrated into the scan head 50 rather than being part of a separate unit, for example a spectrometer enclosure 84. Use of a close coupled detector may minimize a size of the system.

By facilitating a portable and environmentally robust system, the monolithic optical scan head may facilitate the use of the system in areas of increased environmental variation outside of controlled condition, for example in temporary structures such as greenhouses or tents; in clinics; in an outdoor environment such as a field; or mounted to a transport device such as a drone. The system may be used outside of a controlled laboratory environment.

The combination of a scan head with a spectrometer may provide the ability to change spatial, temporal, and spectral resolution through a software application without making a physical or optical change to the system or by making only a limited or minor physical or optical change to the system.

The main mono-block 10 is constructed to provide passage of the optical beam path as described above. Construction of the main mono-block 10 from a single piece of machined material may provide mechanical and/or thermal stability, for example stability of the optical components that are mounted to the main mono-block 10. If the main mono-block 10 were instead to be formed from multiple parts, for example a base part and one or more walls that were formed separately and then coupled together, it may exhibit worse stability and/or heat dissipation properties than a main mono-block 10 that is formed in a single piece. If sufficient heat dissipation were not to be provided, optical misalignment may result and/or the moving mirrors may cease to move or cease to move correctly.

Stability may be provided by the use of direct mounting points to mount components, for example optical components and their associated heat sinks, to the main mono-block 10. The use of direct mounting points for optics and associated heat sinks may provide efficient heat dissipation. Direct mounting and heat dissipation for drive electronics may be provided. In the embodiment of FIGS. 1 to 3, the main mono-block 10 further acts as a direct backplate for the primary mirrors.

In the embodiment of FIGS. 1 to 3, the main mono-block 10 is formed from aluminium. In other embodiments, the main mono-block may be formed from any material having suitable mechanical and thermal properties, such that there is sufficient mechanical stability and thermal removal. For example, the main mono-block may be formed from carbon fibre. Any suitable method of construction may be used.

In some embodiments, the main mono-block is formed using additive manufacture, for example 3D printing. In some embodiments, the main mono-block is formed using a casting process. In some embodiments, the main mono-block is formed using a moulding process.

The scan head of FIGS. 2 and 3 provides a mono-block design for a beam scanning microscope scan head. The scan head 50 may provide direct and ultra-stable mounting of optics, which may provide a highly stable system. The scan head 50 may provide a compact and robust platform.

In other embodiments, a monolithic optical scan head may provide a compact and robust platform for any type of optical imaging, which may include for example steady state fluorescence, time resolve fluorescence, reflectance and/or Raman imaging. In further embodiments, an optical scan head having a mono-block as described above may provide a compact and robust platform for non-linear imaging where dispersion compensation optics may be included. In some embodiments, the optical scan head may be used for the delivery of light for photodynamic therapy and real-time monitoring of said therapy.

In further embodiments, any suitable optical input and output to the scan head may be used to perform any suitable scanning imaging method.

The input/output module 62 is detachable and may be replaced by an alternative and differently configured input/output module in order to provide different functionality, for example to provide different wavelengths of light. The imaging objective unit 72 is also detachable and may be replaced by an alternative and differently configured imaging objective unit, for example to perform an alternative type of imaging, for example free space. In some embodiments, multiple input/output modules and/or multiple imaging objective units are provided. Each of the multiple input/output modules and/or multiple imaging objective units is attachable to the main body of the scan head 50. An input/output module and imaging objective unit may be selected by a user based on which imaging process is to be performed. By using multiple and interchangeable input/output modules and/or imaging objective units, a flexible system may be provided which can be used for multiple different imaging processes. The input/output modules and/or imaging objective units may be easily removed and replaced by a user. In some circumstances, an input/output module may be aligned before it is coupled with the rest of the scan head 50, which may reduce a time or difficulty of setup of the overall system.

In some embodiments, a monolithic optical scan head similar to the monolithic optical scan head 50 described above is used to perform endoscopy, which may be microendoscopy. In addition to the main part of the monolithic optical scan head which is housed in a main mono-block as described above, a mounting mechanism for a removable fibre launch device is directly attached to the main mono-block, for example as part of imaging objective unit 72. An optical fibre, for example optical fibre 76, is used as the system pinhole.

In some embodiments, a close coupled detector and associated optics form part of the scan head. Integration of the close coupled detector may minimise an overall size of the system in which the monolithic optical scan head is used.

The system may be used to deliver light and track biological processes in real time. The system may be used to track exogenous fluorescence or Raman reporters in situ in real time. The system may be to deliver light for photodynamic therapy and track said therapy in real time in situ.

In some embodiments, the scan head may be mounted to a moveable arm which may be used to position the scan head, for example to position the scan head near to a patient. The scan head mounted to a moveable arm may be used, for example, in surgical imaging. The compact size of the scan head may make it possible to mount the scan head on an arm.

In various embodiments, a single detector or a plurality of detectors may be used. The detector or detectors may comprise SPAD (single photon avalanche diode) or SPAD array detectors or photomultipliers. The detector or detectors may comprise at least one large area detector, for example a CCD or CMOS camera. When a single active area detector is used it is configured to detect steady state processes, for example fluorescence, reflectance or non-linear imaging or to detect time-resolved processes including fluorescence lifetime or time-resolved Raman. In some embodiments, multiple excitation lines are displaced temporally enabling multi-channel detection on a single detector. Collected light may be filtered to pass only select wavelengths to the detector.

In embodiments in which a plurality of detectors or array detectors are incorporated, which may include camera formats, collected light may be split into a multitude of wavelengths, each directed to a detector. In some embodiments, the detector or detectors are incorporated into a spectrometer, in the case of array detectors.

In embodiments in which the detector is incorporated into a spectrometer, spectroscopic optics may enable the incorporation of the sensor into a spectroscopic optical system that enables filter-less detection of light, spread by wavelength across the sensor face for photon capture.

In some embodiments, the light source does not comprise a supercontinuum laser as described above. The light accepted by the input/output module 62 may comprise light from any suitable light source, for example a single wavelength diode laser or a plurality of single wavelength diode lasers; a single wavelength, optically pumped solid state or semiconductor laser or a plurality of optical pumped laser sources; a single wavelength LED or a plurality of single wavelength LEDs; a broadband laser source, such as a supercontinuum pulsed laser; a broadband LED source; a tunable laser source suitable for non-linear imaging. The light source may be a continuous wave light source. The light source may be pulsed for time-resolved detection, for example fluorescence lifetime and time gated Raman, including for Raman imaging or sensing in fluorescent samples. Near infrared pulsed sources may be used for multiphoton microscopy including CARS (Coherent Anti-Stokes Raman Scattering) and fluorescence. Dispersion compensation may be integrated into the design.

In some embodiments, laser modules may be interchangeable, which may provide alternative wavelength sources with an easy and rapid change of source.

In some embodiments, a light source and associated optics are integrated into the main mono-block 10. For example, a laser driver and integrated laser diode may be mounted in the main mono-block, removing the need for a fibre input to provide incoming light. Associated temperature control and beam shaping optics may also be mounted in the main mono-block 10.

The input/output module 62 may provide independent beam expansion and reduction for each excitation channel as require to match the scanning optics and imaging objective back aperture.

For multiple or broadband light sources, the input/output module 62 may separate incoming light into multiple spectral bands. The input/output module 62 may provide coalignment of light from different light sources or bands for entry into the scanning optics via optical filters or mirrors, and direction of light into the scanning optics. The input/output module 62 may provide collection of a returned optical signal such as fluorescence, reflectance or Raman scattering, directed towards a secondary objective. The input/output module 62 may provide mechanical, or electro-optical, activation of excitation line(s).

In some embodiments, for example the embodiment of FIGS. 1 to 3, a confocal pinhole used for confocal imaging is an optical fibre of appropriate core side to translate light to a separate detection module (not shown). In other embodiments, the confocal pinhole is a directly aligned pinhole for direction of light to a detector unit that is directly attached to, or forms part of, the monolithic scan head. In some embodiments, a pinhole is not required. Such embodiments may include non-linear imaging, such as multiphoton imaging.

Light input may be provided to the detector module 84 from a multimode fibre 76 or directly from the scan head 50. The detector module 84 may comprise a means of collimation with reduced chromatic aberration, including a lens, such as an achromatic doublet lens or an off-axis parabolic mirror. The detector module 84 may comprise a means of light dispersion, for example a holographic grating, a reflective grating or a prism. The detector module 84 may comprise a means of focusing the dispersed light onto a line sensor, such as a lens including but not limited to achromatic doublet lens, an off-axis parabolic mirror. The detector module 84 may comprise a means for combining light dispersion and focus in a single optic, for example a curved grating. The detector module 84 may comprise a means for rejection of laser lines through spectral channel selection on the sensor to provide filter-less detection. The detector module 84 may comprise a means for selective detection of wavelengths over a given range, determined by the above optics, for example a 10 to 1000 nm bandwidth.

Where the spectrometer detector is a time resolved array, the detector module 84 may comprise a time-resolved line sensor(s) with a plurality of channels, for example 512, with timing resolution of between 10 and 100 ps covering a time window range of between 1 and 20 μs. In other embodiments, any suitable number of channels, any suitable timing resolution, and any suitable time window range may be used. Any suitable sensor may be used. In some embodiments, the detector is capable of computing photon arrival times and histograms at a per channel level enabling calculation of properties including but not limited to fluorescence lifetime, time-gated Raman, CARS for each image pixel. In some embodiment, a sensor is incorporated onto a PCB that co-locates synchronisation circuitry, for example digital to analogue converters, for syncing optical components, for example galvanometric mirrors, with the optical detection of photons. The same PCB may further include an FPGA for processing scan patterns and incoming signals. The inclusion of an FPGA on the same PCB as the detector may remove the requirement for any further external control electronics other than direct mirror drive circuitry.

In the embodiment of FIGS. 1 to 3, infrared light from the supercontinuum laser is filtered out by the input/output module 62. In other embodiments, the input/output module may be configured to provide dispersion compensation if imaging through a fibre bundle, for example to allow the use of femtosecond pulses. Infrared light may be retained and used for imaging or a dedicated infrared source may be used. The imaging process may be a process in which 2 or 3 infrared photons are absorbed simultaneously. Multiphoton imaging may be performed in which all of the light is reflected within the scan head. The multiphoton imaging may include including both fluorescence and/or harmonic generation imaging. The input/output module may facilitate the use of non-linear imaging. The input/output module may facilitate the observation of ultrafast processes, such as transient absorption. A similar configuration may be used for non-linear Raman imaging such as CARS or stimulated Raman imaging.

In further embodiments, the input/output module may provide any suitable form of colour filtering, temporal filtering, compensation and/or conditioning of light.

In some embodiments, no separate input/output module is present. Instead, functionality of the input/output module described above is provided within a single unit, for example within a single main mono-block 10.

In the embodiment of FIGS. 1 to 3, a mounting mechanism is provided for a removable fibre launch device directly attached to the mono-block. The use of a removable imaging objective unit 72 may enable rapid change of fibre types through changeable adaptors. The imaging fibre 74 may be single mode, or multimode or a coherent fibre bundle. The imaging fibre 74 may be polarisation preserving. In other embodiments, the fibre port is replaced with a mechanism for free-space imaging.

The imaging objective unit may provide an optical mounting system that allows imaging with positioning of the imaging fibre including <1 micron resolution in the XY plane, <100 nanometre resolution in Z, which is the focus plane, and a mechanism for rotation of the sample plane to align with a raster scan. In some embodiments, positioning adjustments may be driven manually. In some embodiments, positioning adjustments are driven electronically, which may enable auto-alignment and focus of the imaging fibre.

In embodiments described above, the optical components mounted in the main mono-block comprise main (or primary) mirrors and scanning mirrors (for example, galvo mirrors) and are configured to perform beam scanning in X and Y. In other embodiments, any suitable number and/or type of scanning mirror may be used, and any suitable scanning process may be performed. For example, the scanning may not be a simple XY scan as described above. In further embodiments, the optical components that are mounted in the main mono-block may be configured to perform any suitable manipulation of light, which may or may not comprise scanning. For example, in some embodiments the optical components comprise a spatial light modulator or digital mirror which may be used to manipulate light by performing pattern light projection. For example, pattern light projection may be used for structured illumination or for single pixel imaging. The pattern light projection may be performed with or without scanning.

Embodiments may be used to perform imaging or analysis of any suitable anatomical region, for example any anatomical region that is capable of being accessed via an endoscope. For example, embodiments may be used to perform imaging of the bronchus, gastrointestinal tract, urinary tract, or brain. Imaging may be performed on any suitable human or animal subject. Imaging may be performed for any suitable medical or veterinary application.

It may be understood that the present invention has been described above purely by way of example, and that modifications of detail can be made within the scope of the invention.

Each feature disclosed in the description and (where appropriate) the claims and drawings may be provided independently or in any appropriate combination.

1. An optical device comprising:
a plurality of optical components comprising at least one primary mirror and further comprising at least one scanning mirror component and/or at least one spatial light modulator and/or at least one digital mirror, wherein the plurality of optical components are configured to direct light from an input/output module to an objective module and from the objective module to the input/output module and to manipulate a position and/or pattern of the light; and
a mono-block structure in which the plurality of optical components is mounted, wherein the mono-block structure is a continuous single structure having walls and a base.

2. The optical device according to claim 1, wherein the plurality of optical components comprises at least one scanning mirror component and the manipulating of the light comprises scanning a position of the light.

3. The optical device according to claim 1, further comprising the input/output module and the objective module, wherein the input/output module is configured to receive and/or generate incoming light and to collect reflected and/or transmitted light for sensing or detection, and the objective module is configured to transmit light to and/or receive light from a target.

4. The optical device according to claim 1, wherein at least one of a) and b):
a) components of the input/output module are mounted in the mono-block structure;
b) components of the objective module are mounted in the mono-block structure.

5. The optical device according to wherein at least one of a) and b):
a) the input/output module is removably attachable to the mono-block structure;
b) the objective module is removably attachable to the mono-block structure.

6. The optical device according to claim 1, wherein the mono-block structure is formed by machining a block of a material, optionally wherein the material comprises aluminium.

7. The optical device according to claim 1, wherein the mono-block structure is formed by at least one of: machining, milling, moulding, casting, additive manufacture.

8. The optical device according to claim 1, wherein the mono-block structure is formed of at least one of: aluminium, carbon fibre.

9. The optical device according to as claim 1, further comprising a lid, wherein the mono-block structure and lid are configured to fit together to form an enclosure providing ingress protection.

10. The optical device according to say claim 1, wherein the mono-block structure comprises one or more heat sink elements each comprising a respective plurality of slots or fins.

11. The optical device according to claim 1, wherein the mono-block structure comprises a plurality of mounting points for direct mounting of at least some of the plurality of optical components to the mono-block structure.

12. The optical device according to claim 1, wherein the at least one primary mirror is mounted to at least one wall of the mono-block structure such that the at least one wall of the mono-block structure acts as a fixed backplate to the at least one primary mirror.

13. The optical device according to claim 1, wherein the optical device is configured to perform at least one of: confocal imaging, microendoscopy, multiphoton imaging, free-space imaging, non-linear imaging, ultrafast process imaging, fluorescence imaging, time-resolved fluorescence imaging, Raman imaging, time-resolved Raman imaging.

14. The optical device according to claim 1, wherein the light comprises at least one of visible light, infrared light.

15. The optical device according to claim 1, comprising a detector and detector optics, wherein at least part of the detector and/or the detector optics is mounted in the mono-block structure.

16. The optical device according to claim 1, further comprising a light source and light source optics, wherein at least part of the light source and/or the light source optics is mounted in the mono-block structure.

17. A system comprising the optical device of claim 1 and a detector module configured to perform the sensing or detection.

18. The system according to claim 17, further comprising an imaging fibre that is attachable to the objective module.

19. The system according to claim 17, further comprising a further fibre configured to provide light from the input/output module to the detector module, optionally where the further fibre acts as a system pinhole.

20. The system according to claim 17, wherein the system is portable.

21. The system according to claim 17, further comprising a moveable arm onto which is mounted the optical device of claim 1.

22. A method comprising:
directing, by a plurality of optical components, light from an input/output module to an objective module, wherein the plurality of optical components comprises at least one primary mirror and further comprises at least one scanning mirror component and/or at least one spatial light modulator and/or at least one digital mirror configured to manipulate a position and/or pattern of the light, and wherein the plurality of optical components is mounted in a mono-block structure, wherein the mono-block structure is a continuous single structure having walls and a base; and
directing, by the plurality of optical components, light from the objective module to the input/output module.

23. A method comprising:
forming or receiving a mono-block structure, wherein the mono-block structure is a continuous single structure having walls and a base; and
mounting a plurality of optical components within the enclosure, wherein the a plurality of optical components comprises at least one primary mirror and further comprises at least one scanning mirror component and/or at least one spatial light modulator and/or at least one digital mirror, and wherein the plurality of optical components are configured to direct light from an input/output module to an objective module and from the objective module to the input/output module and to manipulate a position and/or pattern of the light.

24. The method according to claim 23, wherein the mounting comprises directly mounting at least some of the optical components to a plurality of mounting points of the mono-block structure.

25. The method according to claim 23, wherein the mounting comprises mounting at least one primary mirror to at least one wall of the mono-block structure such that the at least one wall of the mono-block structure acts as a fixed backplate to the at least one primary mirror.
